(19) United States
(12) Patent Application Publication
(10) Pub. No.: US 2004/0206585 A1
(43) Pub. Date: Oct. 21, 2004

(54) Parking brake for a motor vehicle

(76) Inventor: Ulf Braker, Berlin (DE)

Correspondence Address: Davidson Davidson & Kappel, 14th Floor, 485 Seventh Avenue, New York, NY, 10018, US

(21) Appl. No.: 10/480,054

(22) PCT Filed: Jun. 4, 2002
(86) PCT No.: PCT/DE02/02029

(30) Foreign Application Priority Data
Jun. 9, 2001 (DE) 201 09 711.7

(51) Int. Cl. F16D 55/08; F16D 55/16

(52) U.S. Cl. 188/2 D

(57) ABSTRACT

The invention relates to a parking brake for a motor vehicle, comprising an actuating lever (1) which is mounted rotatably about an axis (2) and can be fixed releasably in an actuated position, a rotatable drum (3) having a circumferential wall (3a), a spring element (5) being formed from a spring wire (5a), which is arranged in an interior space of the drum (3) and supported from the inside against the circumferential wall (3a) of the drum (3), a traction cable which is fixed to the drum (3), and an adjusting spring (4) which is supported on one side against the drum (3) and on the other side against the actuating lever (1). A parking brake having automatic adjustment control cable, in which infinitely variable adjustment of the control cable is ensured with a few components as possible which can be produced cost-effectively, is achieved that the drum (3) is mounted rotatably about the axis (2), and that a fixed end (5b) of the spring wire (5a) is fixed to the actuating lever (1) outside the drum (3).

The present invention relates to a parking brake for a motor vehicle in accordance with the precharacterizing clause of claim 1.

In modern motor vehicle construction, increasing use is being made of parking brakes in which automatic adjustment of the control cable is provided. An adjustment is generally carried out by means of a spring-loaded element, the element being locked in the direction of traction of the control cable with the aid of the notch/ratchet principle.

U.S. Pat. No. 5,533,420 shows a parking brake, in which the control cable is adjusted by means of a drum which can be connected to an actuating lever in a rotationally fixed manner in one direction via an internal coupling spring designed as a helical spring. In the other direction, the drum can be rotated relative to the actuating lever, since in this direction the frictional action of the drum carries along the coupling spring in such a manner that the coupling spring is tapered in its diameter, as a result of which ultimately the coupling force is neutralized. In contrast, the friction of the drum in the rotationally fixed direction acts in an expanding manner on the coupling spring to the effect that there is a frictionally engaged, self-reinforcing, rotationally fixed connection between the drum and actuating lever. The control cable for actuating the brake is fixed here on the drum from the outside. An automatic adjustment of the control cable is ensured by an adjusting spring which is used to continuously subject the drum to a force in the direction in which it can be rotated relative to the actuating lever. In the process, the drum can be rotated about an axis which is arranged at a distance from an axis of rotation of the actuating lever, which means that, overall, a multiplicity of components are required. In addition, the coupling spring is supported by means of an inwardly bent end of its spring wire against the actuating lever. This results in a large buckling moment at the end of the spring wire, at least in the case of helical springs, the inside diameter of which is large in comparison with the diameter of the spring wire. Accordingly, in the arrangement shown, use is made of an internal coupling spring which has a relatively small inside diameter. A sufficiently large, friction-reduced retaining moment of the drum when the parking brake is actuated is difficult to achieve here and is helped in turn by the spring wire being formed with a rectangular cross section. However, spring elements of this type are complex and expensive special production items.

It is the object of the invention to provide a parking brake having automatic adjustment of the control cable, in which infinitely variable adjustment of the control cable is ensured with as few components as possible which can be produced cost-effectively.

The invention achieves this object for the parking brake mentioned at the beginning by the characterizing features of claim 1.

A common mounting of the drum and actuating lever is advantageously made possible here by the drum and the actuating lever being rotatable about the same axis. In addition, in a parking brake according to the invention, simple and secure supporting of the spring wire is ensured by the supported or fixed end of the spring wire being led essentially tangentially out of the drum. This advantageously also enables the use of a spring element in which the diameter is large in comparison to the diameter of the spring wire.

In a preferred development of a parking brake according to the invention, apertures are provided in the circumferential wall of the drum, both the fixed end and a free end of the spring wire being led out of the drum through the apertures. In this case, in a non-actuated position of the parking brake, the actuating lever can advantageously be supported against the free end, with the result that, in this non-actuated position of the parking brake, such that the spring element does not produce a rotationally fixed connection between the drum and the actuating lever.

A latch element is preferably formed on the actuating lever, the latch element being secured on the actuating lever by clamping and being arranged in a plane with the actuating lever. The effect advantageously achieved by this is that only the latch element has to be formed from a harder material in accordance with requirements and at the same time the construction of the actuating lever and latch element is flat as though the notches were formed directly on the actuating lever.

In a preferred embodiment of a parking brake according to the invention, the drum is advantageously provided with a base plate, a recess being formed by means of a molding of the base plate. The adjusting spring can thus advantageously be arranged within the recess of the drum, as a result of which the space enclosed by the circumferential wall of the drum contains both the spring element and the adjusting spring and a space-saving construction of a parking brake according to the invention is therefore made possible.

In a preferred development, the traction cable of a parking brake according to the invention is fixed on the outside of the circumferential wall of the drum. In this case, the traction cable is particularly preferably turned once or more about the drum, so that the holding action caused thereby enables a lug or a device for securing the end of the traction cable to be of correspondingly simple and compact design.

Further advantages and features of a parking brake according to the invention emerge from the exemplary embodiment described below and from the dependent claims.

A preferred exemplary embodiment of a parking brake according to the invention will be described below and explained in greater detail with reference to the attached drawings.

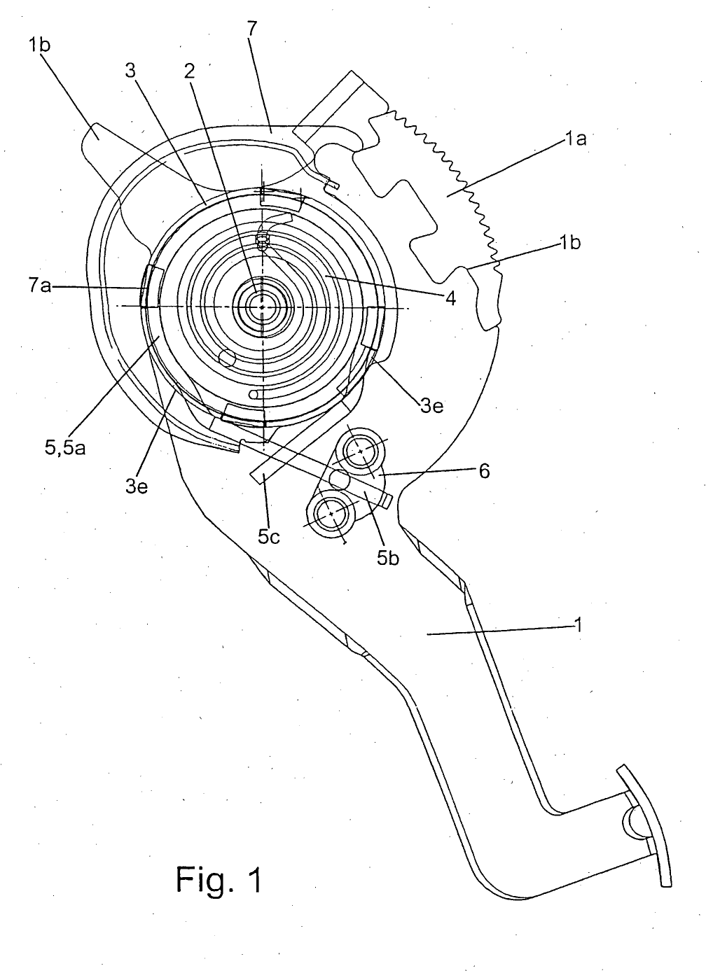

FIG. 1 shows a schematic side view of a parking brake according to the invention.

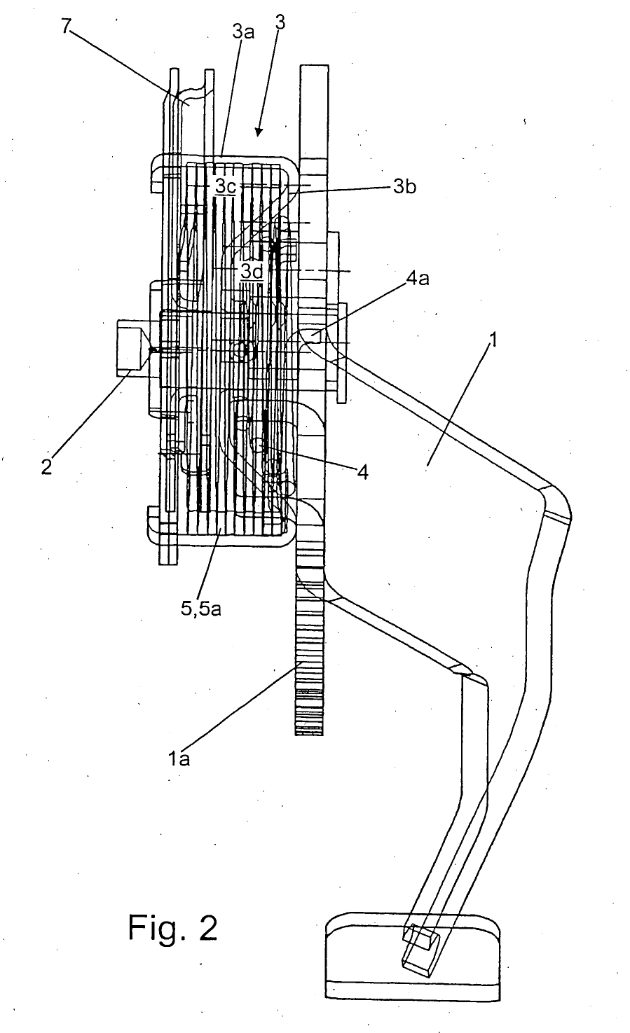

FIG. 2 shows a plan view from above of a parking brake according to the invention from FIG. 1.

The parking brake according to the invention which is shown in FIG. 1 comprises an actuating lever 1 which is designed as a pedal and is mounted rotatably about an axis 2 and a latch element 1a is secured on the actuating lever 1 by clamping by means of corresponding recesses 1b. As can be seen in FIG. 2, the latch element 1a and a plate-like region of the actuating lever 1 lie in a plane. Furthermore, a stop 1b is formed on the actuating lever 1.

A drum 3 is mounted rotatably about the axis 2. The drum 3 consists essentially of a sheet metal formed part and has a circumferential wall 3a which defines an interior space 3c of the drum. A base plate 3b of the drum 3 is shaped in a conically tapering manner, resulting in the formation of a recess 3d in which an adjusting spring 4 is arranged. The adjusting spring 4 is fixed by one end 4a of its spring wire to the actuating lever 1 and by another end of its spring wire to the drum 3, with the result that the drum is acted upon by a torque in the clockwise direction of rotation (see FIG. 1) by means of a pretensioning of the adjusting spring 4.

A spring element 5, which is designed as a helical spring coiled from a spring wire 5a, is arranged in the interior space 3c of the drum 3 and is supported from the inside against the circumferential wall 3a of the drum 3 by the coils of the spring wire 5a. A fixed end 5b is led out of the drum 3 by means of apertures 3e of the circumferential wall 3a and is secured on the actuating lever 1 by means of an abutment 6.

A free end 5c of the spring wire 5a is likewise led out of the drum 3 by means of apertures 3e of the circumferential wall 3a. In a non-actuated position of the actuating lever 1 of the parking brake, the free end 5c strikes against a stop (not illustrated) which is fixed onto a bodywork part.

A cable-holding part 7 is connected fixedly to the drum 3 by means of clamps 7a. A traction cable (not illustrated) leading to a brake of the vehicle is fixed to the cable-holding part 7 and is guided in the cable-holding part 7, such that the traction cable encircles the drum 3 or the cable-holding part 7 approximately in the form of a semicircle.

The invention functions as follows:

In a non-actuated position of the actuating lever 1, the actuating lever 1 is held in its position by the traction cable of the brake and by the stop 1b. In this case, the adjusting spring 4 rotates the drum 3 about the axis 2 in the clockwise direction until the traction cable of the brake is pretensioned and without play. The rotation in the clockwise direction is made possible by the spring element having in this direction little if any locking action on the rotation of the drum 3 relative to the actuating lever 1. An additional reduction of the locking action in the non-actuated position of the actuating lever 1 can be achieved by the fact that, in this position, a stop (not illustrated) which is fixed on the bodywork acts on the free end 5c of the spring element 5, as a result of which the spring element 5 is tapered, and rubbing with the circumferential wall 3a of the drum 3 is reduced or entirely stopped.

If the actuating lever is pivoted in the clockwise direction (see FIG. 1) about the axis 2, then the rubbing of the spring element against the circumferential wall 3a is directed in such a manner that the spring element 5 is expanded radially and the rubbing is therefore increased. This ensures that the drum 3 is carried along counter to the force of the traction cable and corresponding to the rotation of the actuating lever 1.

A fixing of the actuating lever in an actuated position is ensured in a known manner by means of the latch element 1a and a ratchet device (not illustrated). A release of the actuating lever takes place in a manner which is likewise known by means of a release device which is actuated, for example, by a control cable and by means of which the ratchet and the latch element are brought out of engagement. A resetting of the actuating lever is then brought about by the restoring force of the traction cable of the brake.

1-10. (canceled)

11. A parking brake for a motor vehicle, the parking brake comprising
an actuating lever configured to rotate about an axis;
a drum mounted rotatably about said axis, said drum having an interior space and a circumferential wall;
a spring element formed from a spring wire having a fixed end, said spring wire being arranged in the interior space of said drum and being supported from the inside against the circumferential wall;
a traction cable fixed to the drum; and
an adjusting spring having a first end and a second end, said adjusting spring being supported on the first end against the drum and on the second end against the actuating lever,
wherein the fixed end of the spring wire is fixed to the actuating lever outside the drum.

12. The parking brake as claimed in claim 11, wherein the circumferential wall of said drum a first aperture, the fixed end of the spring wire being led out of the drum through the first aperture.

13. The parking brake as claimed in claim 11, wherein the spring wire provides further a free end being led out of the drum.

14. The parking brake as claimed in claim 13 further comprising a stop fixed on a bodywork of the motor vehicle, said stop contacting against said free end of the spring wire in a non-actuated position of the parking brake.

15. The parking brake as claimed in claim 11 further comprising a latch element formed on the actuating lever, wherein the latch element is secured to the actuating lever by clamping and is arranged in a plane with the actuating lever.

16. The parking brake as claimed in claim 11, wherein the drum includes a base plate moulded so as to form a recess.

17. The parking brake as claimed in claim 16, wherein the adjusting spring is arranged within the recess.

18. The parking brake as claimed in claim 11, wherein the drum includes a cable-holding portion for the traction cable.

19. The parking brake as claimed in claim 11, wherein the traction cable at least partially encircles the drum.

20. The parking brake as claimed in claim 11, wherein said actuating lever can be releasably fixed in an actuated position.

21. A parking brake for a motor vehicle, the parking brake comprising
an actuating lever configured to rotate about an axis;
a drum mounted rotatably about said axis, said drum having an interior space;
a spring element formed from a spring wire, said spring wire being arranged in the interior space of said drum in a frictional manner;
a traction cable fixed to the drum; and
an adjusting spring having a first end and a second end, said adjusting spring being supported on the first end against the drum and on the second other end against the actuating lever,
wherein actuating the actuating lever causes an expansion of the spring wire to increase the friction between the spring wire and the drum in order to rotate the drum about the axis for tensioning the traction cable.
